(19) United States
(12) Patent Application Publication
(10) Pub. No.: US 2005/0067518 A1
(43) Pub. Date: Mar. 31, 2005

(54) Wear ring assembly for centrifugal rock crusher turntables

(76) Inventor: Brett M. Rose, Vancouver, WA (US)

Correspondence Address: OLSON AND OLSON, 5412 SE FOSTER ROAD, PORTLAND, OR, 97206, US

(21) Appl. No.: 10/949,663

(22) Filed: Sep. 23, 2004

Related U.S. Application Data
(60) Provisional application No. 60/506,248, filed on Sep. 25, 2003.

(51) Int. Cl. B02C 19/00

(52) U.S. Cl. 241/275

(57) ABSTRACT

This invention is a wear ring assembly for centrifugal rock crushers, and it comprises an annular wear ring member of hardened, brittle metal preferably having a Brinell hardness number of 600-800, a chrome content of 12-30% by weight and a carbon content of 2.6-3.3% by weight. The annular wear ring member forms an infeed opening for delivery of rock to the rock crusher. A bolt ring member of softer metal of high strength and resistance to breaking is secured over the wear ring member to protect the rock crusher from damage by high velocity fragments of hard, brittle wear ring material which would otherwise occur when the wear ring member would fracture under the impact force of large pieces of rock introduced into the rock crusher. In one embodiment the wear ring member is formed as a plurality of segments which are secured together as an annular ring by an overlying bolt ring which also secures a second annular wear ring member forming the upper portion of the annular opening.

This application claims benefit of Provisional application Ser. No. 60/506,248, Filed 25 Sep. 2003.

### BACKGROUND OF THE INVENTION

This invention relates to rock crushers, and more particularly to a novel wear ring assembly for centrifugal rock crushers.

In order to assure that all of the incoming rock material is thrown outwardly into impact with the anvil assembly of a centrifugal rock crusher, a wear ring cap member is typically secured to the upper side of the impeller assembly of a rock crusher turntable to form an overlying top cap cover member with a central opening therethrough for passage of rock onto the turntable and into the impeller spaces between the underlying turntable and overlying top cap wear ring member. Heretofore, wear rings have been provided as simple disc-like metal plates provided with annular bolt holes therethrough positioned to correspond with threaded bores in a plurality of impeller units secured to the turntable.

Typically, wear rings of the prior art currently are made of an approximately 4% chrome steel alloy material having a hardness of approximately 400 Brinell, which is a comparatively soft material that wears rather rapidly, typically about the life of 2-4 sets of impellers. While this material suffers the disadvantage of a comparatively short wear life, it is less susceptible to the occurrence of shattering and breaking under these operating conditions than wear rings made of harder and more brittle material that has greater wear lives. The extensive damage that results to the rock crusher apparatus when a broken fragment of a hardened wear ring member is thrown off at high speed, is considered generally to outweight the shorter wear life of the softer material ring members that are less susceptible to breaking and cracking under operation.

### SUMMARY OF THE INVENTION

In its basic form, the wear ring assembly of this invention includes a base ring member having a hardness of 600 to 800 Brinell and a chrome content of 12-30% and a carbon content of 2.6-3.3% by weight, and an overlying bolt ring formed of softer steel exhibiting high strength and resistance to cracking and breaking.

It is the principal objective of this invention to provide a wear ring assembly that overcomes the limitations and disadvantages of prior wear rings for centrifugal rock crushers.

Another objective of this invention is the provision of a wear ring assembly that utilizes harder and more brittle materials having greatly increased wear characteristics, while assuring against separation of hard fragments that could cause damage to the rock crusher in the event the ring member should break during operation.

Still another objective of this invention is to provide a wear ring assembly of the class described in which a hardened wear ring is coupled with an overlying bolt ring of softer steel which protects against separation of hard fragments if the wear ring should break, and thereby minimize damage to the rock crusher.

A further objective of this invention is to provide a wear ring assembly formed of a plurality of segments secured together in an annular configuration by an overlying bolt ring.

A still further objective of this invention is the provision of a wear ring assembly of simplified construction for economical manufacture and repair.

The foregoing and other objects and advantages of this invention will appear from the following detailed description, taken in connection with the accompanying drawings of preferred embodiments.

### BRIEF DESCRIPTION OF THE DRAWINGS

FIG. 1 is a fragmentary sectional view of a first embodiment of wear ring of this invention shown with an overlying rock infeed funnel in broken lines and a plurality of supporting rock impeller units also shown in fragmentary, broken line form.

FIG. 2 is an exploded perspective view of the wear ring assembly of FIG. 1.

FIG. 3 is a cross sectional view, similar to FIG. 1, showing a second embodiment of wear ring assembly, the same being shown supported upon impeller units in fragmentary, broken line form.

FIG. 4 is an exploded perspective view of the wear ring assembly of FIG. 3.

FIG. 5 is a cross sectional view, similar to FIGS. 1 and 3, showing a third embodiment of wear ring assembly supported on impeller units shown in fragmentary, broken line form.

FIG. 6 is an exploded perspective view of the wear ring assembly of FIG. 5.

FIG. 7 is a fragmentary cross section on an enlarged scale of the left end portion of FIG. 5.

### DESCRIPTION OF THE PREFFERED EMBODIMENTS

The wear ring assembly of this invention provides a structure capable of utilizing harder and more brittle materials having greatly increased wear characteristics while additionally providing means that assures against separation of wear ring fragments that could cause damage to the rock crusher in the event the ring member should break during operation.

FIGS. 1 and 2 illustrate a first embodiment of wear ring assembly embodying the features of this invention. FIG. 1 also shows the wear ring assembly supported on a plurality of underlying impeller units 10, 10 of a centrifugal rock crusher. The wear ring assembly also is shown in positioned position beneath a feed hopper 12 of a centrifugal rock crusher, the feed hopper being shown in broken lines. FIG. 1 illustrates a sectional view through the wear ring assembly and FIG. 2 provides a perspective view of the component parts of the wear ring assembly.

As best shown in FIG. 2, the wear ring assembly of this embodiment comprises two interengaging ring members: a base, wear surface ring member 14 and an overlying bolt ring member 16. Those skilled in the art will recognize that the outer diameter of the wear ring base member 14 is dimensioned to correspond with the diameter of the turntable of a centrifugal rock crusher and also with the impeller system 10 to which the wear ring is mounted.

In its preferred form, the base wear ring member 14 is formed of a metal composition selected for particular hardness and long wear characteristics. As an example, the base member may be formed of ASTM A532 Chrome White Iron with a hardness of 600 to 800 Brinell and having a chrome content of 12 to 30% by weight and a carbon content of 2.6 to 3.3% by weight. This results in a ring member having wear surfaces that offer a wear life of 5 to 10 times longer than the aforementioned conventional wear ring constructions, although the composition is more brittle and therefore potentially more susceptible to cracking and breaking. However, as seen in FIGS. 1 and 2, the base member 14 is configured with a raised, rounded central portion 18 defining and annular opening 20 forming a raised annular shoulder or ledge 22 extending vertically from the upper planar surface 24 of the base member 14. The overlying bolt ring member 16 is configured with a central opening 26 that is slightly larger in diameter than the diameter of the annular ledge 22 in order that when the bolt ring 16 is disposed on the upper planar face 24 of the base member 16, the edge of the central opening closely encircles the projecting ledge portion 22.

Corresponding bores 28, 28′ are provided through the base member 14 and bolt ring 16, respectively in predetermined spaced apart arrangement corresponding to the pattern of threaded mounting bores (not shown) associated with an impeller configuration of a rock crusher for securement by mounting bolts 30. In the particular embodiment of FIG. 2, the bolt bore pattern 28, 28′ reflects a wear ring configured for mounting on a rock crusher turntable having an array of six impeller assemblies.

Assembled and installed on the turntable assembly of a rock crusher, the bolt ring 16, which is formed of a softer, for example 4% chrome alloy steel or mild steel for high strength and resistance to cracking and breaking, firmly reinforces and strengthens the harder and brittle base ring member 14 which is effectively clamped between the bolt ring member and the underlying impeller structure.

As will be apparent to those skilled in the art, the capturing engagement of the bolt ring 16 with the raised shoulder or ledge 22 positively retains the base ring member 14 against separation should it crack, break or otherwise fracture during operation of the rock crusher. In such an event, the base ring member 14, even broken or fragmented will be retained in position, held by the bolt ring 16, against being propelled explosively outward by the effects of centrifugal force.

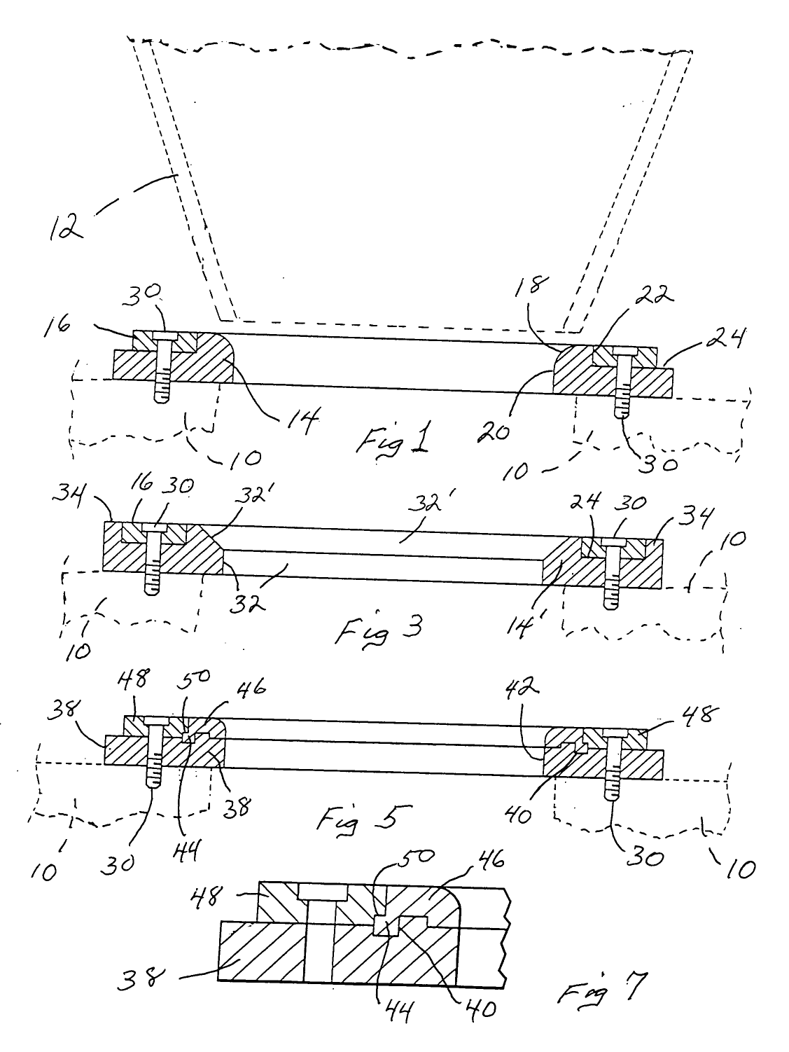

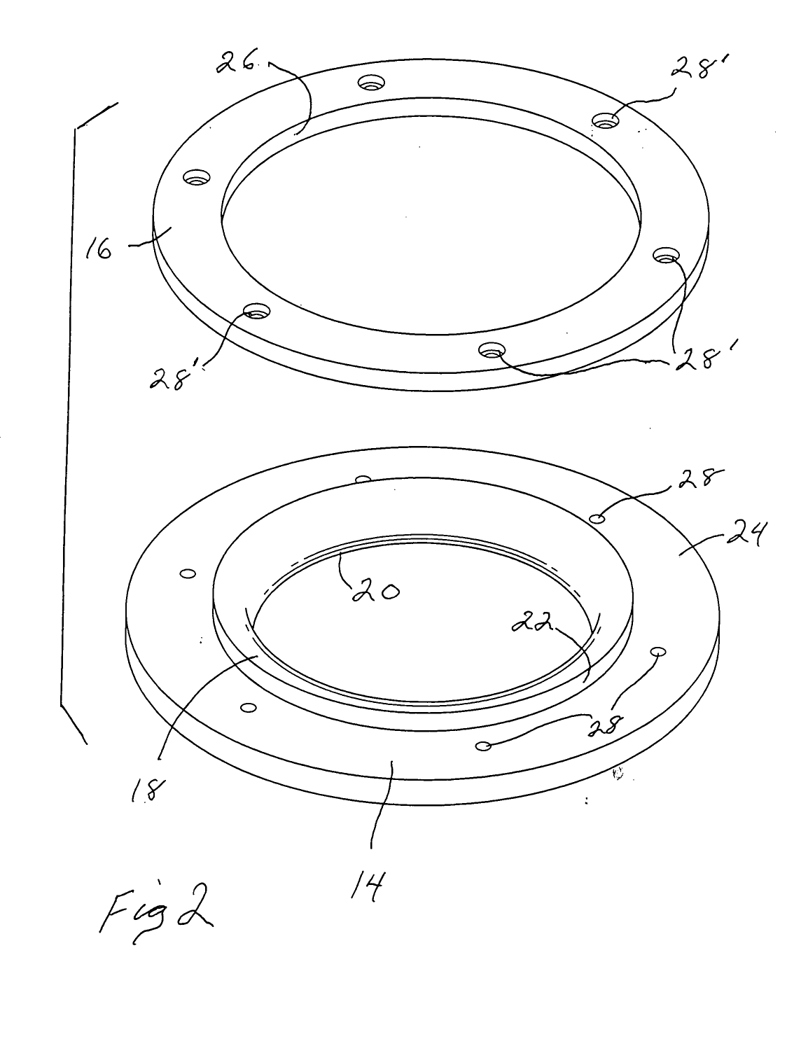

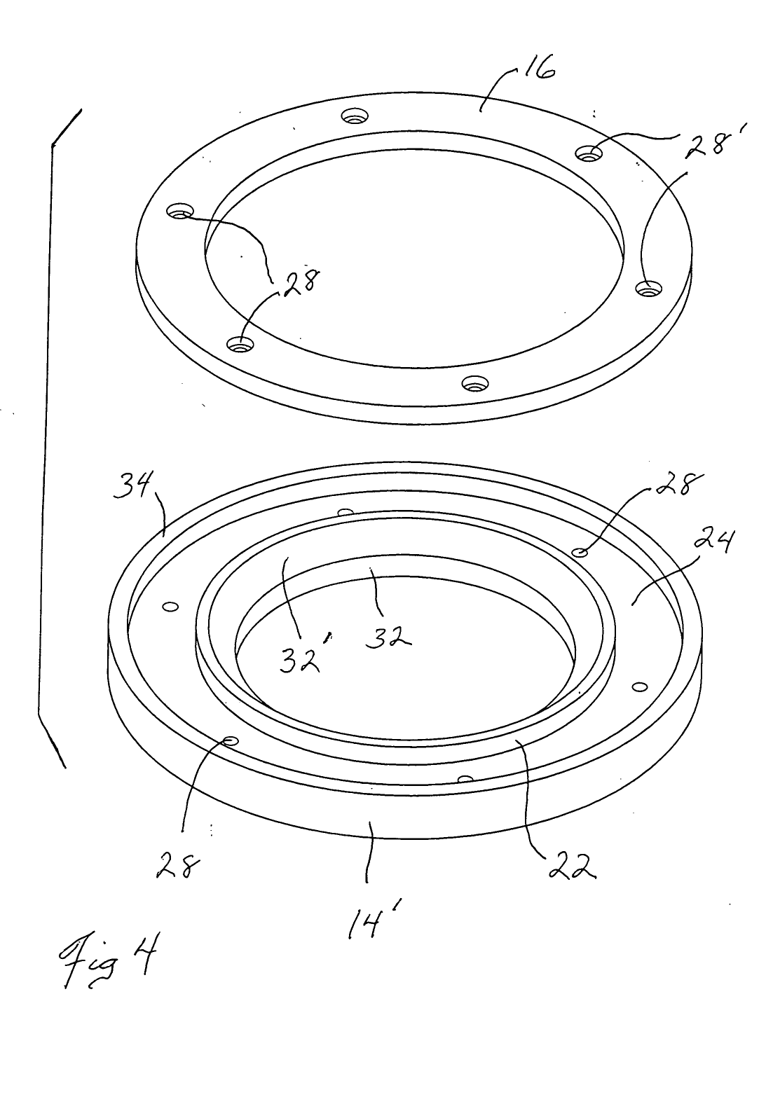

FIGS. 3 and 4 illustrate a second embodiment of the wear ring assembly of this invention, differing from the first embodiment by having a central annular wear opening 32 associated with a tapered or chamfered surface 32′, as distinguished from the rounded configuration 18 of the first embodiment. Further, the outer peripheral edge of the base wear ring member 14′ is provided with an outer raised shoulder or ledge 34 which adds strength and rigidity to the base wear ring member when it is worn and/or broken. The raised edge 34 also serves to protect the bolt ring 16 from wear and abrasion during operation of the centrifugal rock crusher.

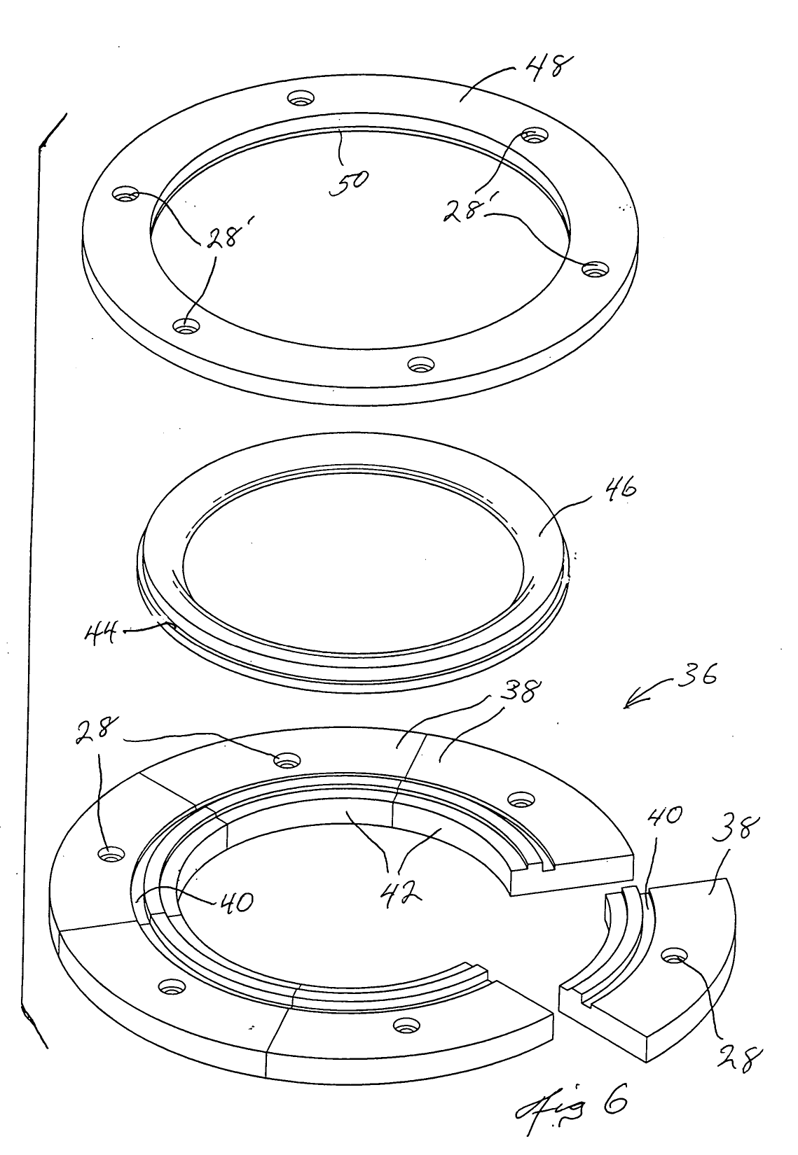

FIGS. 5, 6 and 7 illustrate a third embodiment of the wear ring assembly of this invention which utilizes a segmented base wear ring configuration and a separate, central, annular wear surface ring member and bolt ring member for securing the assembly together. In this embodiment, the wear ring member 36 (FIG. 6) is formed of a plurality of separate, identical segments 38. Each segment is configured with a locking groove 40 (FIG. 7) that combines with the other segments of the ring to form an annular seating ring encircling the inner opening 42 of the ring member for mating, seated interengagement of the corresponding annular tab 44 on the central annular wear ring member 46 which overlies the segmented annular ring member 36. An overlying bolt ring member 48 is configured with an inner annular notch 50 arranged to overly and capture the tab 44 when the bolt ring is placed into overlying position on the base ring member 36. Mounting bolt bores 28, 28″ are provided as described in connection with the earlier embodiments, for mounting the assembly on the turntable of a centrifugal rock crusher.

It will be recognized by those skilled in the art that both the bolt ring 48 and the central annular wear ring 46 interengage to secure the segments of the base ring member 36 against separation, should the base ring member be damaged or broken during operation of the rock crusher. This segmented base ring construction and separate central annular wear ring 46 affords a more simplified and economical manufacture of the wear ring assembly of this invention, as well as providing more convenient handling and storage, simpler installation and removal during maintenance and repair operations.

It will be apparent to those skilled in the art that many changes and modifications, other than those previously described, may be made in the size, shape, type, number and arrangement of parts described hereinbefore without departing from the spirit of this invention and the scope of the appended claims.

Having thus described my invention and the manner in which it may be used,

1. A wear ring assembly for centrifugal rock crushers, comprising:
a) an annular base ring member of hardened, brittle metal, and
b) an annular bolt ring member of high strength and resistance to breaking, overlying and secured to the base ring member.

2. The wear ring assembly of claim 1 wherein the base ring member has a hardness of 600-800 Brinell.

3. The wear ring assembly of claim 2 wherein the base ring member has a chrome content of 12-30% by weight and a carbon content of 2.6-3.3% by weight.

4. The wear ring assembly of claim 1 wherein the bolt ring member is mild steel having high strength and resistance to cracking or breaking.

5. The wear ring assembly of claim 1 wherein the base ring member has a hardness of 600-800 Brinell, a chrome content of 12-30% by weight and a carbon content of 2.6-3.3% by weight, and the bolt ring member is chrome alloy steel or mild steel having high strength and resistance to cracking or breaking.

6. The wear ring assembly of claim 1 wherein the wear ring member comprises a plurality of segments configured to form an annular ring, the bolt ring member is configured to overly the segments, and fastener means removably secures the segments and bolt ring member together.

7. The wear ring assembly of claim 6 including a second wear ring member configured to overly the first named wear ring member adjacent the annular opening in the first named wear ring member, the bolt ring member being configured to overly the first named wear ring member and a portion of the second wear ring member for securing the second wear ring member to the first named wear ring member.
